(19) United States
(12) Patent Application Publication
(10) Pub. No.: US 2026/0290824 A1
(43) Pub. Date: Sep. 24, 2026

(54) POROUS CARBON MATERIAL AND PREPARATION METHOD THEREOF, AND SILICON-CARBON MATERIAL AND APPLICATION THEREOF

(71) Applicant: Ningde Amperex Technology Limited, Ningde (CN)

(72) Inventor: Xianghuan LIU, Ningde (CN)

(73) Assignee: Ningde Amperex Technology Limited, Ningde (CN)

(21) Appl. No.: 19/571,625

(22) Filed: Mar. 19, 2026

(30) Foreign Application Priority Data
Mar. 19, 2025 (CN) 202510329060.6

(51) Int. Cl. H01M 4/587; C01B 32/318; C01B 32/348; H01M 10/0525; H01M 10/0568; H01M 10/0569

(52) U.S. Cl. CPC H01M 4/587; C01B 32/318; C01B 32/348; H01M 10/0525; H01M 10/0568; H01M 10/0569; C01P 2004/80; C01P 2006/12; C01P 2006/14; C01P 2006/16; C01P 2006/40; H01M 2300/0034; H01M 2300/0037

(57) ABSTRACT

A porous carbon material, a method of preparing the porous carbon material, and a silicon-carbon material comprising the porous carbon material are provided. When a button cell assembled from the porous carbon material and lithium metal is charged at a current of 0.05C within a voltage range of 0.005 V to 2 V, a specific charge capacity within a voltage range of 0.005 V to 0.15 V is 43 mAh/g to 132 mAh/g, and a specific charge capacity within a voltage range of 0.005 V to 0.8 V is 152 mAh/g to 253.4 mAh/g; where a differential voltage-capacity dQ/dV curve of the porous carbon material has a first characteristic peak located at 0.005-0.15 V, and a peak height is not less than 260 mAh/g/V.

### CROSS-REFERENCE TO RELATED APPLICATION

The present application claims priority to Chinese Patent application No. 202510329060.6 filed in the China National Intellectual Property Administration on Mar. 19, 2025, the entire content of which is hereby incorporated by reference.

### TECHNICAL FIELD

This application belongs to the field of energy storage technologies, and specifically relates to a porous carbon material and a preparation method therefor, and a silicon-carbon material and application thereof.

### BACKGROUND

Conventional graphite negative electrode materials have a theoretical energy density as low as 372 mAh/g, which limits their further development and application, whereas silicon materials have attracted widespread attention in recent years due to their high energy density of 4200 mAh/g. Currently, most common silicon-carbon materials adopt a skeleton of amorphous porous carbon materials with nanoscale pores, and nano-silicon crystals are deposited inside the pores through vapor deposition. The silicon-carbon material is an energy storage carrier formed by an amorphous porous carbon material matrix and amorphous nano-silicon crystals. As a candidate material for a new generation of high-energy-density lithium-ion batteries, it combines high theoretical capacity of silicon and good conductivity of carbon materials, and in theory can increase the energy density of batteries, showing great potential in enhancing battery energy storage capacity.

However, silicon-carbon materials still face the technical challenge of low first-cycle Coulombic efficiency in practical applications, and silicon undergoes volume swelling during lithium intercalation. This not only leads to battery capacity degradation but also destroys the battery structure, affecting the cycling performance. Therefore, how to effectively improve the first-cycle Coulombic efficiency and cycling performance of silicon-carbon materials used in batteries has become an urgent technical problem that needs to be solved in the current field of battery materials.

### SUMMARY

In view of this, this application provides a porous carbon material and a preparation method therefor, and a silicon-carbon material and application thereof. The porous carbon material has a high reversible capacity, helping enhance the overall capacity and first-cycle efficiency of a silicon-carbon negative electrode material and improve the cycling performance of a secondary battery.

This application provides a porous carbon material, where the porous carbon material and lithium metal are assembled into a button cell, and when the button cell is charged at a current of 0.05C within a voltage range of 0.005 V to 2 V, a specific charge capacity within a voltage range of 0.005 V to 0.15 V is 43 mAh/g to 132 mAh/g, and a specific charge capacity within a voltage range of 0.005 V to 0.8 V is 152 mAh/g to 253.4 mAh/g; where a differential voltage-capacity dQ/dV curve of the porous carbon material has a first characteristic peak located at 0.005-0.15 V, and a peak height of the first characteristic peak is not less than 260 mAh/g/V. The porous carbon material can provide some specific charge capacity in a low voltage range of 0.005 V to 0.15 V, and the differential voltage-capacity dQ/dV curve has the first characteristic peak located at 0.005-0.15 V with a high peak height of not less than 260 mAh/g/V, meaning that the porous carbon material allows rapid intercalation of massive lithium ions in this voltage range. In other words, the porous carbon material features high lithium ion transport capability in the low voltage range of 0.005 V to 0.15 V and can increase the capacity at a low voltage plateau. This helps speed up lithium ion intercalation and deintercalation, and especially improves the electrochemical performance of a secondary battery under high-rate conditions. In addition, as mentioned above, such specific charge capacity is provided in the voltage range of 0.005 V to 0.8 V It indicates that the porous carbon material contributes to a high capacity during charging in this voltage range, thereby further enhancing the overall capacity and energy density of the silicon-carbon material, and the capacity in that voltage range helps improve the first-cycle Coulombic efficiency of the silicon-carbon material. Furthermore, it indicates that the porous carbon material has structures for lithium deintercalation and intercalation in that voltage range, and lithium ions intercalate and deintercalate gently in that voltage range. This helps reduce the stress on the material, better mitigates the swelling of nano-silicon, and enhances the structural stability, thereby improving the cycling performance of the silicon-carbon material and the secondary battery.

In some embodiments, a true density of the porous carbon material is 2.003 g/cm³ to 2.230 g/cm³; and at least a portion of the porous carbon material has a lattice structure. In this application, a lattice structure is provided in the porous carbon material, so that lithium ions can intercalate between layers of the lattice structure like in graphite materials, providing some lithium storage capacity for the porous carbon material. The lattice structure can further increase the diffusion rate of lithium ions, thereby improving the rate performance of the secondary battery. In addition, when the true density of the porous carbon material falls within the foregoing range, it indicates that the porous carbon material has an appropriate amount of closed-pore structures which do not communicate with the outer surface, but lithium ions can diffuse into the closed-pore structures through diffusion channels provided by the lattice structure and intercalate into the closed-pore structures in a controlled manner to form lithium metal clusters. This further increases the reversible lithium storage capacity of the porous carbon material and reduces the waste of lithium-storage space inside the porous carbon material. In addition, pores with smaller diameters are preferentially closed during formation of the closed-pore structures, so that more nano-silicon is deposited in pores with larger diameters. This further mitigates the swelling of nano-silicon, and reduces the swelling and side reactions of the negative electrode material, improving the cycling performance of the secondary battery. Therefore, the lattice structure and closed-pore structures described in this application can increase the reversible lithium storage capacity and lithium ion diffusion rate of the porous carbon material, enabling the porous carbon material to provide a high specific charge capacity in the voltage range of 0.005 V to 0.8 V. Moreover, the differential voltage-capacity dQ/dV curve has the first characteristic peak, improving the first-cycle Coulombic efficiency of the silicon-carbon material as well as the rate performance and cycling performance of the secondary battery.

In some embodiments, the peak height of the first characteristic peak is 260 mAh/g/V to 1927 mAh/g/V. When this condition is satisfied, the first-cycle Coulombic efficiency, rate performance, and cycling performance of the secondary battery can be further improved.

In some embodiments, the porous carbon material satisfies at least one of the following:
(1) when the button cell is charged at a current of 0.05C within a voltage range of 0.005 V to 2 V, the specific charge capacity within a voltage range of 0.005 V to 0.15 V is 75 mAh/g to 132 mAh/g, and the specific charge capacity within a voltage range of 0.005 V to 0.8 V is 174 mAh/g to 253.4 mAh/g; or
(2) the peak height of the first characteristic peak is 760 mAh/g/V to 1927 mAh/g/V. When the porous carbon material satisfies the foregoing conditions, with the help of the closed pores and lattice structure, the first-cycle Coulombic efficiency, rate performance, and cycling performance of the secondary battery can be further improved.

In some embodiments, a specific surface area of the porous carbon material is 1752 m²/g to 2035 m²/g; and/or a pore volume of the porous carbon material is 0.68 cm³/g to 0.91 cm³/g. When the porous carbon material satisfies the foregoing conditions, an area of contact between the porous carbon material and the electrolyte can be increased, helping fully utilize the lithium ion channels for intercalation into a microcrystalline structure and its closed pores. This can further improve the first-cycle Coulombic efficiency, rate performance, and cycling performance of the secondary battery.

In some embodiments, the porous carbon material has first pores and second pores, the first pore has a pore size of P₁ nm, and the second pore has a pore size of P₂ nm, where 0<P₁≤2 nm and 2<P₂≤10 nm; where, based on a sum of a pore volume of the first pores and a pore volume of the second pores, a pore volume percentage of the first pores is 92.4% to 98.2%, preferably, 93.2% to 96.5%. The porous carbon material with these pore size distribution characteristics can provide more lithium ion diffusion channels and further enhance lithium ion diffusion, with the help of the microcrystalline structure, thereby further improving the first-cycle Coulombic efficiency and rate performance of the secondary battery. Such pore size distribution plus the closed-pore structures can jointly mitigate the volume change of silicon during charging and discharging and improve the stability of the battery structure, thereby improving the cycling performance of the secondary battery.

This application further provides a method for preparing the foregoing porous carbon material. The method includes the following steps:
step S1: dispersing a catalytic elemental metal to obtain a dispersion system; and polymerizing a monomer in the dispersion system to obtain a porous carbon material precursor; where the catalytic elemental metal includes at least one of iron, cobalt, nickel, vanadium, chromium, manganese, zinc, tin, calcium, magnesium, or aluminum; a mass percentage of the catalytic elemental metal in the porous carbon material precursor is 0.004% to 0.500%; and the monomer includes a phenolic compound and an aldehydic compound;
step S2: carbonizing the porous carbon material precursor at T₁° C. for t₁ hours to obtain a carbonized material, where 750° C.≤T₁≤1200° C. and 1≤t₁≤10;
step S3: mixing the carbonized material with an activator and then activating the mixture at T₂° C. for t₂ hours to obtain an activated material, where 700° C.≤T₂≤1100° C. and 1≤t₂≤6; and
step S4: washing and then drying the activated material; and roasting the dried activated material at T₃° C. for t₃ hours in a mixed gas atmosphere of an alkane (for example, methane) and an inert gas (for example, nitrogen) to obtain the porous carbon material, where 600° C.≤T₃≤1400° C., 2≤t₃≤8, and a volume ratio of the alkane to the inert gas is 1:(5-10).

In this application, a catalytic metal is added to the porous carbon material precursor, and under the high-temperature conditions of subsequent carbonization treatment and activation treatment, a lattice structure can be catalytically formed inside the porous carbon material to increase lithium storage capacity and lithium ion diffusion rate. After the activation ends, closed-pore structures can be formed in the porous carbon material through roasting treatment in the alkane gas, further increasing the reversible lithium storage capacity of the porous carbon material as well as improving the effects of mitigating the swelling of nano-silicon. This improves the first-cycle Coulombic efficiency, cycling performance, and rate performance of the secondary battery.

This application further provides a silicon-carbon material, where the silicon-carbon material includes a porous carbon material, nano-silicon located inside the porous carbon material, and a carbon layer located on a surface of the porous carbon material; where the porous carbon material includes the foregoing porous carbon material or a porous carbon material prepared using the foregoing preparation method. Depending on the porous carbon material therein, the silicon-carbon material of this application has higher lithium storage capacity and first-cycle Coulombic efficiency, and can improve the cycling performance and rate performance of the secondary battery.

This application further provides a secondary battery including a positive electrode, a negative electrode, and an electrolyte. In some embodiments, the negative electrode includes a negative electrode current collector and a negative electrode material layer located on at least part of a surface of the negative electrode current collector, and the negative electrode material layer includes the foregoing silicon-carbon material.

In some embodiments, the electrolyte contains ethylene carbonate and fluoroethylene carbonate; where based on mass of the electrolyte, a mass percentage of ethylene carbonate is C₁%, a mass percentage of fluoroethylene carbonate is C₂%, and 0.5≤C₂/C₁≤2; preferably, 1≤C₂/C₁≤1.5. With the mass percentages of ethylene carbonate and fluoroethylene carbonate in the electrolyte controlled within the foregoing range, the film-forming effect of the electrolyte and wettability of the negative electrode material can be improved. This promotes the formation of a stable solid electrolyte interface film (SEI film) on the surface of the foregoing silicon-carbon material or porous carbon material, reduces side reactions of the electrolyte, and reduces the resistance to diffusion of lithium ions, further improving the cycling performance and rate performance of the secondary battery.

In some embodiments, the electrolyte contains a first lithium salt, and the first lithium salt is selected from at least one of lithium bis(trifluoromethanesulfonyl)imide, lithium bis(fluorosulfonyl)imide, and lithium trifluoromethanesulfonate; and the electrolyte contains a second lithium salt, and the second lithium salt is selected from at least one of lithium tetrafluoroborate or lithium difluorophosphate; where based on mass of the electrolyte, a mass percentage of the first lithium salt is S₁% and a mass percentage of the second lithium salt is S₂%, where 0.2≤S₂/S₁≤2; preferably, 0.4≤S₂/S₁≤1.6. When the electrolyte contains the first lithium salt and second lithium salt, the compactness and stability of the SEI film can be improved and the ionic conductivity of the electrolyte can be increased. This can further improve the cycling performance and rate performance of the secondary battery when combined with the foregoing negative electrode system.

This application further provides an electronic apparatus including the foregoing secondary battery. Depending on the foregoing porous carbon material contained in the negative electrode of the secondary battery, the electronic apparatus of this application features excellent endurance and high safety performance.

### BRIEF DESCRIPTION OF DRAWINGS

FIG. 1 is a diagram of charge-discharge cycling curves of porous carbon materials provided by Example 1-1 and Comparative Example 1-1 of this application; and

FIG. 2 is a diagram of differential voltage-capacity dQ/dV curves of porous carbon materials provided by Example 1-1 and Comparative Example 1-1 of this application.

### DETAILED DESCRIPTION OF EMBODIMENTS

To make the objectives, technical solutions, and advantages of this application clearer, this application will be further described in detail below with reference to embodiments. It should be understood that the specific embodiments described herein are only used to explain this application and are not intended to limit this application.

A silicon-carbon material is an energy storage carrier formed by a porous carbon material matrix and nano-silicon. The porous carbon material is amorphous and provides a limited capacity. Due to high specific surface area of the porous carbon material, more active sites are provided but the loss of irreversible lithium ions is increased during initial charging and discharging, thereby reducing the first-cycle Coulombic efficiency. Consequently, the capacity and first-cycle Coulombic efficiency of silicon-carbon materials cannot be fully realized.

This application provides a porous carbon material, where the porous carbon material and lithium metal are assembled into a button cell. When the button cell is charged at a current of 0.05C within a voltage range of 0.005 V to 2 V, a specific charge capacity within a voltage range of 0.005 V to 0.15 V is 43 mAh/g to 132 mAh/g, preferably, 75 mAh/g to 132 mAh/g, for example, 43 mAh/g, 50 mAh/g, 60 mAh/g, 70 mAh/g, 80 mAh/g, 90 mAh/g, 100 mAh/g, 110 mAh/g, 132 mAh/g, or a value within a range defined by any two of these values; and a specific charge capacity within a voltage range of 0.005 V to 0.8 V is 152 mAh/g to 253.4 mAh/g, preferably, 174 mAh/g to 253.4 mAh/g, for example, 152 mAh/g, 160 mAh/g, 174 mAh/g, 170 mAh/g, 180 mAh/g, 190 mAh/g, 200 mAh/g, 210 mAh/g, 220 mAh/g, 230 mAh/g, 240 mAh/g, 250 mAh/g, 253.4 mAh/g, or a value within a range defined by any two of these values.

A differential voltage-capacity dQ/dV curve of the porous carbon material has a first characteristic peak located at 0.005-0.15 V, and a peak height of the first characteristic peak is 260 mAh/g/V to 1927 mAh/g/V Preferably, the peak height of the first characteristic peak is 760 mAh/g/V to 1927 mAh/g/V For example, the peak height of the first characteristic peak may be 260 mAh/g/V, 330 mAh/g/V, 620 mAh/g/V, 740 mAh/g/V, 1090 mAh/g/V, 1240 mAh/g/V, 1540 mAh/g/V, 1760 mAh/g/V, 1927 mAh/g/V, or a value within a range defined by any two of these values.

The inventors have found that when the porous carbon material has the foregoing characteristics, it can provide some specific charge capacity in a lower voltage range of 0.005 V to 0.15 V, and such capacity helps improve the first-cycle Coulombic efficiency of the porous carbon material and the silicon-carbon material. The differential voltage-capacity dQ/dV curve has the first characteristic peak located at 0.005-0.15 V with a high peak height, meaning that the porous carbon material allows rapid intercalation of massive lithium ions in this voltage range. In other words, the porous carbon material features high lithium ion transport capability in that low voltage range, which can promote the stable formation of an SEI film in the low voltage range, helping reduce side reactions and improve the first-cycle Coulombic efficiency of the porous carbon material and the silicon-carbon material. In addition, as mentioned above, such specific charge capacity is provided in the voltage range of 0.005 V to 0.8 V It indicates that that the porous carbon material contributes to a high capacity during the entire charging process, thereby further enhancing the overall capacity and energy density of the silicon-carbon material. Furthermore, it indicates that the porous carbon material has pore structures for lithium deintercalation and intercalation in that voltage range, and these structures can better mitigate the swelling of nano-silicon and enhance the structural stability, thereby improving the cycling performance of the silicon-carbon material and the secondary battery.

In some embodiments, a true density of the porous carbon material is 2.003 g/cm³ to 2.230 g/cm³; and at least a portion of the porous carbon material has a lattice structure. For example, the true density of the porous carbon material may be 2.003 g/cm³, 2.012 g/cm³, 2.032 g/cm³, 2.055 g/cm³, 2.093 g/cm³, 2.127 g/cm³, 2.137 g/cm³, 2.162 g/cm³, 2.193 g/cm³, 2.230 g/cm³, or a value within a range defined by any two of these values. When the true density of the porous carbon material falls within this range, it indicates that the porous carbon material has some closed-pore structures. When the porous carbon material has lattice structures, they can provide intercalation sites and diffusion paths for lithium ions, so that lithium ions diffuse into the closed-pore structures through the lattice structures and intercalate into the closed-pore structures in a controlled manner by means of forming lithium clusters, thereby increasing lithium storage capacity. Through their cooperation, the reversible lithium storage capacity of the porous carbon material can be increased, so that the porous carbon material provides some specific charge capacity in the foregoing voltage ranges and the differential voltage-capacity dQ/dV curve has the first characteristic peak. The microcrystalline structure can further increase the diffusion rate of lithium ions, thereby improving the rate performance of the secondary battery. Pores with smaller diameters are preferentially closed during formation of the closed-pore structures, so that more nano-silicon is deposited in pores with larger diameters. This further mitigates the swelling of nano-silicon, and reduces the swelling and side reactions of the negative electrode material, improving the cycling performance of the secondary battery.

In some embodiments, the electrical conductivity of the porous carbon material is 5 S/cm to 20 S/cm, for example, 5 S/cm, 6 S/cm, 7 S/cm, 8 S/cm, 9 S/cm, 10 S/cm, 11 S/cm, 12 S/cm, 13 S/cm, 14 S/cm, 15 S/cm, 16 S/cm, 17 S/cm, 18 S/cm, 19 S/cm, 20 S/cm, or a value within a range defined by any two of these values. The microcrystalline structure in the porous carbon material can increase the diffusion rate of lithium ions and increase the electrical conductivity to the foregoing range. This can further improve the first-cycle Coulombic efficiency, rate performance, and cycling performance of the secondary battery when combined with the closed-pore structures.

In some embodiments, a specific surface area of the porous carbon material is 1752 m²/g to 2035 m²/g, for example, 1752 m²/g, 1770 m²/g, 1900 m²/g, 1990 m²/g, 2035 m²/g, or a value within a range defined by any two of these values. When the porous carbon material satisfies this condition, combined with its closed pores and microcrystalline structure, the first-cycle Coulombic efficiency, rate performance, and cycling performance of the secondary battery can be further improved.

In some embodiments, a pore volume of the porous carbon material is 0.68 cm³/g to 0.91 cm³/g, for example, 0.68 cm³/g, 0.73 cm³/g, 0.79 cm³/g, 0.81 cm³/g, 0.84 cm³/g, 0.88 cm³/g, 0.91 cm³/g, or a value within a range defined by any two of these values. When the porous carbon material satisfies this condition, combined with its closed pores and microcrystalline structure, the first-cycle Coulombic efficiency, rate performance, and cycling performance of the secondary battery can be further improved.

In some embodiments, the porous carbon material has first pores and second pores, the first pore has a pore size of P₁ nm, and the second pore has a pore size of P₂ nm, where 0<P₁≤2 nm and 2<P₂≤10 nm; where, based on a sum of a pore volume of the first pores and a pore volume of the second pores, a pore volume percentage of the first pores is 92.4% to 98.2%. For example, based on the sum of the pore volume of the first pores and the pore volume of the second pores, the pore volume percentage of the first pores is 92.4%, 93.5%, 93.6%, 94.7%, 95.0%, 96.0%, 96.9%, 97.2%, 97.9%, 98.1%, 98.2%, or a value within a range defined by any two of these values. The porous carbon material with these pore size distribution characteristics can provide more lithium ion diffusion channels, and further improve the diffusion capability for lithium ions, with the help of the microcrystalline structure, thereby further increasing the first-cycle Coulombic efficiency and rate performance of the secondary battery. Such pore size distribution plus the closed-pore structures can jointly mitigate the volume change of silicon during charging and discharging and improve the stability of the battery structure, thereby improving the cycling performance of the secondary battery.

This application further provides a method for preparing the foregoing porous carbon material. The method includes the following steps:
step S1: dispersing a catalytic elemental metal to obtain a dispersion system; and polymerizing a monomer in the dispersion system to obtain a porous carbon material precursor; where the catalytic metal includes at least one of iron, cobalt, nickel, vanadium, chromium, manganese, zinc, tin, calcium, magnesium, or aluminum; the porous carbon material precursor contains the catalytic elemental metal, a mass percentage of the catalytic elemental metal in the porous carbon material precursor is 0.004% to 0.500%; and the monomer includes a phenolic compound and an aldehydic compound;
step S2: carbonizing the porous carbon material precursor at T₁° C. for t₁ hours to obtain a carbonized material, where 750° C.≤T₁≤1200° C. and 1≤t₁≤10;
step S3: mixing the carbonized material with an activator and then activating the mixture at T₂° C. for t₂ hours to obtain an activated material, where 700° C.≤T₂≤1100° C. and 1≤t₂≤6; and
step S4: washing and then drying the activated material; and roasting the dried activated material at T₃° C. for t₃ hours in a mixed gas atmosphere of an alkane and an inert gas to obtain the porous carbon material, where 600° C.≤T₃≤1400° C., 2≤t₃≤8, and a volume ratio of the alkane to the inert gas is 1:(5-10).

In this application, a catalytic metal is added to the porous carbon material precursor, and under the high-temperature conditions of subsequent carbonization treatment and activation treatment, a lattice structure can be catalytically formed inside the porous carbon material to increase lithium storage capacity and lithium ion diffusion rate. After the activation ends, closed-pore structures can be formed in the porous carbon material through roasting treatment in the alkane gas, further increasing the reversible lithium storage capacity of the porous carbon material as well as improving the effects of mitigating the swelling of nano-silicon. This improves the first-cycle Coulombic efficiency, cycling performance, and rate performance of the secondary battery.

In this application, the dispersion system is used to provide a solvent system in which the polymerization reaction occurs, and the catalytic metal is added to the porous carbon material precursor during the polymerization reaction. This application does not particularly limit the dispersion system as long as the objective of this application can be achieved. For example, a catalyst, such as sodium hydroxide or potassium hydroxide, may also be added to the dispersion system for catalyzing the polymerization reaction of the monomer.

In some embodiments, the temperature of the carbonization treatment T₁° C. satisfies 750° C.≤T₁≤1200° C. For example, T₁ may be 750, 770, 830, 850, 950, 950, 1040, 1060, 1110, 1150, 1200, or a value within a range defined by any two of these values. The duration of the carbonization treatment is t₁ hours, where 1≤t₁≤10. For example, t₁ may be 1, 2, 3, 4, 5, 6, 7, 8, 10, or a value within a range defined by any two of these values.

In some embodiments, the temperature for the activation treatment is T₂° C., and T₂ satisfies 700° C.≤T₂≤1100° C. For example, T₂ may be 700, 740, 770, 800, 870, 890, 950, 980, 1050, 1070, 1100, or a value within a range defined by any two of these values. The duration of the activation treatment is t₂ hours, where 1≤t₂≤6. For example, t₂ may be 1, 2, 3, 4, 5, 6, or a value within a range defined by any two of these values.

In some embodiments, the temperature of the roasting treatment T₃° C. satisfies 600° C.≤T₃≤1400° C. For example, T₃ may be 600, 680, 730, 860, 880, 970, 1080, 1140, 1220, 1370, 1400, or a value within a range defined by any two of these values. The duration of the roasting treatment is t₃ hours, where 2≤t₃≤8. For example, t₃ may be 2, 3, 4, 5, 6, 7, 8, or a value within a range defined by any two of these values.

In some embodiments, deionized water and/or an acid liquid may be used for the washing treatment.

This application further provides a silicon-carbon material, where the silicon-carbon material includes a porous carbon material, nano-silicon located inside the porous carbon material, and a carbon layer located on a surface of the porous carbon material; where the porous carbon material includes the foregoing porous carbon material or a porous carbon material prepared using the foregoing preparation method. Depending on the porous carbon material therein, the silicon-carbon material of this application has higher lithium storage capacity and first-cycle Coulombic efficiency, and can improve the cycling performance and rate performance of the secondary battery. The carbon layer may cover partial or entire surface of the porous carbon material. When the proportion of the surface of the porous carbon material covered by the carbon layer increases, the cycling performance and rate performance of the secondary battery can be further improved.

In this application, the silicon-carbon material may be prepared by subjecting the porous carbon material to silane vapor deposition, for example, using a method including the following steps: heating the porous carbon material to 400° C. to 600° C. in an inert atmosphere, introducing silane gas for chemical vapor deposition and maintaining the temperature for 2 hours to 8 hours, adjusting the temperature at 450° C. to 650° C., and then introducing acetylene gas for 1 hour to 4 hours of reaction, to obtain the silicon-carbon material.

This application further provides a secondary battery including a positive electrode, a negative electrode, and an electrolyte. In some embodiments, the negative electrode includes a negative electrode current collector and a negative electrode material layer located on at least part of a surface of the negative electrode current collector, and the negative electrode material layer includes the foregoing silicon-carbon material.

### Secondary Battery

The secondary battery of this application is not particularly limited and is classified into various categories depending on the type of electron transport substance. For example, when the electron transport substance is lithium (Li, including ions), the secondary battery is a lithium-ion battery; and when the electron transport substance is sodium (Na, including ions), the secondary battery is a sodium-ion battery. Taking a secondary battery as an example, this application will be described below with reference to the embodiments of this application. It should be noted that in the specific embodiments of this application, a lithium-ion battery is used as an example of the secondary battery to explain this application, but the secondary battery of this application is not limited to lithium-ion batteries.

According to an embodiment of this application, the secondary battery may include a battery cell and an electrolyte. The battery cell may include a packaging material and an electrode assembly disposed inside the packaging material, and the electrolyte may be filled in the internal space formed by the packaging material. The packaging material can protect the electrode assembly from external impact and prevent the electrolyte from leaking to the outside. Depending on the shape of the packaging material, the battery cell may be prismatic, cylindrical, or pouch type.

The electrode assembly includes a positive electrode, a negative electrode, and a separator, as well as other components known in the art in secondary batteries, which are not limited in this application. The separator may be disposed between the positive electrode and the negative electrode.

This application does not particularly limit the preparation method of a secondary battery. For example, the method may include the following steps: stacking the positive electrode, the separator, and the negative electrode in sequence, and winding or folding them as required to obtain an electrode assembly, placing the electrode assembly into a packaging material, and injecting the electrolyte into the packaging material and sealing, to obtain a secondary battery.

### Positive Electrode

In this application, the positive electrode is not particularly limited as long as the objective of this application can be achieved. The positive electrode includes a positive electrode current collector and a positive electrode material layer disposed on at least one surface of the positive electrode current collector. Disposing the positive electrode material layer on at least one surface of the positive electrode current collector means that the positive electrode material layer may be located on one surface of the positive electrode current collector in its thickness direction or on both surfaces of the positive electrode current collector in its thickness direction. It should be noted that the “surface” herein may be partial or entire area of the surface of the positive electrode current collector, which is not particularly limited in this application as long as the objective of this application can be achieved.

This application does not particularly limit the type, size, and shape of the positive electrode current collector as long as it does not cause chemical changes in the battery cell and is conductive. For example, the positive electrode current collector may be made of stainless steel, aluminum, nickel, titanium, calcined carbon, or a material obtained by treating the surface of aluminum or stainless steel with carbon, nickel, titanium, silver, or the like. In this application, the positive electrode current collector may further contain a non-metal element. For example, the non-metal element includes at least one of fluorine, phosphorus, boron, chlorine, silicon, or sulfur.

The positive electrode current collector may have an appropriate thickness as required. Although not particularly limited, the positive electrode current collector may have a thickness in the range of 1 μm to 500 μm, 1 μm to 300 μm, 1 μm to 100 μm, 1 μm to 50 μm, or 1 μm to 20 μm.

Unless otherwise specified, the terms thickness (or height), width, and length used in this application refer to average values, and can be measured by measuring instruments capable of measuring thickness (or height), width, and length respectively and according to methods known in the art.

Fine concavities and convexities may be formed on the surface of the positive electrode current collector, further enhancing the adhesion to the positive electrode material layer. For example, the form of the positive electrode current collector may be one or more selected from a group consisting of foil, sheet, film, net, porous body, foam, and non-woven fabric.

In this application, the positive electrode material layer includes a positive electrode active material, and this application does not particularly limit the type of the positive electrode active material as long as the objective of this application can be achieved. For example, the positive electrode active material may include at least one of lithium nickel cobalt manganate (LiNi_{0.90}Co_{0.05}Mn_{0.05}O₂(NCM₉₅₅), NCMs₁₁, NCM₆₂₂, NCM₅₂₃, NCM₁₁₁), lithium nickel cobalt aluminate, lithium iron phosphate, lithium vanadium phosphate, lithium cobalt phosphate, lithium manganese phosphate, lithium manganese iron phosphate, lithium-rich manganese-based material, lithium cobalt oxide (LiCoO₂), lithium iron silicate, lithium vanadium silicate, lithium cobalt silicate, lithium manganese silicate, spinel lithium manganese oxide, spinel lithium nickel manganese oxide, or lithium titanate. In this application, the positive electrode active material may alternatively contain a non-metal element. For example, the non-metal element includes at least one of fluorine, phosphorus, boron, chlorine, silicon, or sulfur. In this application, the thicknesses of the positive electrode current collector and the positive electrode material layer are not particularly limited as long as the objective of this application can be achieved.

In some embodiments, the positive electrode material layer may further include a positive electrode binder. This application does not particularly limit the type of the positive electrode binder as long as the objective of this application can be achieved. For example, the positive electrode binder may include but is not limited to at least one of polyvinylidene fluoride, polytetrafluoroethylene, polyolefin, sodium carboxymethyl cellulose, lithium carboxymethyl cellulose, modified polyvinylidene fluoride, modified styrene-butadiene rubber (SBR), polyene ester, polyenol, polyacrylic acid, or polyurethane. In some embodiments, the polyolefin binder includes at least one of polyethylene or polypropylene.

In some embodiments, the positive electrode material layer may further include a conductive agent. This application does not particularly limit the type of the conductive agent in the positive electrode material layer as long as the objective of this application can be achieved. In some exemplary embodiments, the conductive agent includes a carbon-based material, for example, graphite such as natural graphite or artificial graphite, carbon black such as acetylene black, Ketjen black, channel black, furnace black, lamp black, or thermal black, or carbon fiber; a conductive polymer, for example, a polyphenyl derivative; a conductive metal oxide, for example, zinc oxide or titanium oxide; a conductive whisker, for example, potassium titanate; or a mixture formed by any combination of these substances.

In this application, the positive electrode material layer may be formed by applying a positive electrode slurry on at least one surface of the positive electrode current collector and drying, and then the slurry may be calendered as required. The positive electrode slurry includes the foregoing positive electrode active material, positive electrode binder, and conductive agent. In addition, the positive electrode slurry may further include a solvent, and this application does not particularly limit the type of the solvent as long as the objective of this application can be achieved. For example, the solvent may be N-methyl-2-pyrrolidone.

This application does not particularly limit the mass ratio of the positive electrode active material, conductive agent, and positive electrode binder in the positive electrode material layer, and those skilled in the art may select according to actual needs as long as the objective of this application can be achieved. A known mass ratio may be used.

### Negative Electrode

This application does not particularly limit the negative electrode as long as the objective of this application can be achieved. For example, the negative electrode includes a negative electrode current collector and a negative electrode material layer disposed on at least one surface of the negative electrode current collector. In this application, the negative electrode material layer may be disposed on one surface of the negative electrode current collector in its thickness direction or on both surfaces of the negative electrode current collector in its thickness direction. It should be noted that the “surface” herein may be partial or entire area of the surface of the negative electrode current collector, which is not particularly limited in this application as long as the objective of this application can be achieved.

This application does not particularly limit the type, size, and shape of the negative electrode current collector as long as it does not cause chemical changes in the battery cell and is conductive. For example, the negative electrode current collector may be made of stainless steel, copper, nickel, titanium, calcined carbon, or a substance obtained by treating the surface of copper or stainless steel with carbon, nickel, titanium, silver, or the like.

The negative electrode current collector may have an appropriate thickness as needed. Although not particularly limited, the negative electrode current collector may have a thickness in the range of 1 μm to 500 μm, 1 μm to 300 μm, 1 μm to 100 μm, 1 μm to 50 μm, 1 μm to 20 μm, or 5 μm to 10 μm.

Fine concavities and convexities may be formed on the surface of the negative electrode current collector, further enhancing the adhesion to the negative electrode material layer. For example, the form of the negative electrode current collector may be one or more selected from a group consisting of foil, sheet, film, net, porous body, foam, and non-woven fabric.

The negative electrode material layer of this application includes a negative electrode active material, where the negative electrode active material includes the foregoing silicon-carbon material. Based on mass of the negative electrode material layer, a mass percentage of potassium element is C ppm, where 1≤C≤100. For example, C may be 1, 8, 12, 24, 41, 49, 66, 77, 86, 95, 100, or a value within a range defined by any two of these values. When the mass percentage of potassium element in the negative electrode material layer is controlled within this range, the ionic conductivity and swelling suppression performance of the secondary battery can be further improved.

In some embodiments, the negative electrode active material may further include another material, for example, including but not limited to, a carbon material such as graphite (artificial graphite, natural graphite, or graphitized carbon fiber) or amorphous carbon; a metal capable of being alloyed with lithium or a lithium alloy such as Si, Al, Sn, Pb, Zn, Bi, In, Mg, Ga, Cd, Si alloy, Sn alloy, or Al alloy; a metal oxide, capable of being doped with lithium or with lithium dedoped, or a lithium alloy such as SiO_{β} (0<β≤2), SnO, SnO₂, vanadium oxide, or lithium vanadium oxide; a composite containing the metal and carbon material such as a Si—C composite or a Sn—C composite; spinel-structure lithium titanate TiO₂—Li₄T₁₅O₁₂, or any one thereof or a mixture of two or more thereof. Specifically, the carbon material may be low-crystallinity carbon, high-crystallinity carbon, or the like. Representative low-crystallinity carbon is soft carbon and hard carbon. An example of high-crystallinity carbon may be amorphous, plate-shaped, flake-shaped, spherical, or fibrous natural graphite or artificial graphite, pristine graphite, pyrolytic carbon, mesophase pitch-based carbon fiber, carbon microsphere (mesophase carbon microsphere), mesophase pitch, or high-temperature calcined carbon such as petroleum or coal-based coke (coke derived from petroleum or coal tar pitch).

The negative electrode material layer in this application further includes a negative electrode binder. This application does not particularly limit the type of the negative electrode binder as long as the objective of this application can be achieved. For example, the negative electrode binder may include but is not limited to at least one of polyvinylidene fluoride (PVDF), polyvinyl alcohol, styrene-butadiene rubber (SBR), polyethylene oxide, carboxymethyl cellulose (CMC), hydroxypropyl cellulose, cellulose acetate, cellulose diacetate, cellulose acetate butyrate, cellulose acetate propionate, cyanoethyl pullulan, cyanoethyl polyvinyl alcohol, cyanoethyl cellulose, cyanoethyl sucrose, pullulan, polymethyl methacrylate, polybutyl acrylate, polyacrylonitrile, polyvinylpyrrolidone, polyvinyl acetate, an ethylene-vinyl acetate copolymer, polyarylate, polyvinyl chloride, carboxylated polyvinyl chloride, polyvinyl fluoride, a polymer containing ethylene oxide, polyurethane, polytetrafluoroethylene, polyethylene, polypropylene, polyacrylic acid, styrene-butadiene rubber, acrylated styrene-butadiene rubber, epoxy resin, or nylon.

This application does not particularly limit the type of the conductive agent in the negative electrode material layer as long as the objective of this application can be achieved. In some exemplary embodiments, the conductive agent includes a carbon-based material, for example, graphite such as natural graphite or artificial graphite, carbon black such as acetylene black, Ketjen black, channel black, furnace black, lamp black, or thermal black, or carbon fiber; a metal-based material, for example, metal powder or metal fiber of copper, nickel, aluminum, silver, or the like; a conductive polymer, for example, a polyphenyl derivative; a conductive metal oxide, for example, zinc oxide or titanium oxide; a conductive whisker, for example, potassium titanate; or a mixture formed by any combination of these substances.

This application does not particularly limit the mass ratio of the negative electrode active material, negative electrode conductive agent, and negative electrode binder in the negative electrode material layer, and those skilled in the art may select according to actual needs as long as the objective of this application can be achieved. A known mass ratio may be used.

In this application, the negative electrode material layer may be formed by applying a negative electrode slurry on at least one surface of the negative electrode current collector and drying, and then the slurry may be calendered as required. The negative electrode slurry includes the foregoing negative electrode active material and negative electrode binder, and may further include a conductive agent when required. In addition, the negative electrode slurry may further include a solvent, and this application does not particularly limit the type of the solvent as long as the objective of this application can be achieved. For example, the solvent may be deionized water.

### Separator

The separator of this application is used to prevent short circuit between the positive electrode and the negative electrode while allowing the passage of electron transport substances. This application does not particularly limit the separator as long as the objective of this application can be achieved. For example, a material of the separator may include but is not limited to at least one of polyethylene (PE)- and polypropylene (PP)-based polyolefin (PO), a polyester (for example, polyethylene terephthalate (PET) membrane), cellulose, polyimide (PI), polyamide (PA), spandex, or aramid; and the type of the separator may include at least one of woven membrane, non-woven membrane, microporous membrane, composite membrane, calendered membrane, or spun membrane.

According to some embodiments of this application, the separator may include a substrate layer and a surface treatment layer. The substrate layer may be a non-woven fabric, membrane, or composite membrane having a porous structure, and a material of the substrate layer may include at least one of polyethylene, polypropylene, polyethylene terephthalate, or polyimide. Optionally, a polypropylene porous membrane, a polyethylene porous membrane, a polypropylene non-woven fabric, a polyethylene non-woven fabric, or a polypropylene-polyethylene-polypropylene porous composite membrane may be used.

Optionally, the surface treatment layer is disposed on at least one surface of the substrate layer, and the surface treatment layer may be a polymer layer, an inorganic substance layer, or a layer formed by mixing a polymer and an inorganic substance. For example, the inorganic substance layer contains inorganic particles and a binder. The inorganic particle is not particularly limited in this application, and may, for example, include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. This application does not particularly limit the binder, which may be, for example, at least one of the foregoing positive electrode binder or negative electrode binder. The polymer layer contains a polymer, which is not particularly limited in this application. For example, the polymer includes at least one of polyamide, polyacrylonitrile, acrylate polymer, polyacrylic acid, polyacrylate, polyvinylpyrrolidone, polyvinyl ether, polyvinylidene fluoride, or poly(vinylidene fluoride-hexafluoropropylene). In this application, the thickness of the separator is not particularly limited as long as the objective of this application can be achieved. For example, the thickness of the separator may be 5 μm to 500 μm.

### Electrolyte

In this application, the electrolyte refers to a medium that causes electron transport substances to move for smooth electrochemical reactions of the positive electrode and the negative electrode. The electrolyte may be a commonly used organic liquid electrolyte, inorganic liquid electrolyte, gel polymer electrolyte, molten inorganic electrolyte, or the like, which is not limited thereto. A solid electrolyte such as a gel polymer electrolyte may alternatively be used instead of the electrolyte. A battery using a solid electrolyte is generally called a solid-state battery or an all-solid-state battery. A liquid electrolyte (electrolyte) generally contains a non-aqueous solvent and a lithium salt.

In some embodiments, the electrolyte contains ethylene carbonate and fluoroethylene carbonate, where based on mass of the electrolyte, a mass percentage of ethylene carbonate is C₁%, a mass percentage of fluoroethylene carbonate is C₂%, and 0.5≤C₂/C₁≤2; preferably, 1≤C₂/C₁≤1.5. For example, the value of C₂/C₁ may be 0.5, 0.8, 0.9, 1.1, 1.2, 1.4, 1.5, 1.8, 1.9, 2, or a value within a range defined by any two of these values. With the mass percentages of ethylene carbonate and fluoroethylene carbonate in the electrolyte controlled within the foregoing range, the film-forming effect of the electrolyte and wettability of the negative electrode material can be improved. This promotes the formation of a stable solid electrolyte interface film (SEI film) on the surface of the foregoing silicon-carbon material or porous carbon material, reduces side reactions of the electrolyte, and reduces the resistance to diffusion of lithium ions, further improving the cycling performance and rate performance of the secondary battery.

In some embodiments, 5≤C₁≤12. For example, the value of C₁ may be 5, 6, 7, 8, 9, 10, 11, 12, or a value within a range defined by any two of these values. In some embodiments, 2.5≤C₂≤20. For example, the value of C₂ may be 2.5, 3, 6, 7, 9, 12, 14, 16, 17, 19, 20, or a value within a range defined by any two of these values. When the foregoing condition is satisfied, the cycling performance and rate performance of the secondary battery can be further improved.

In some embodiments, the electrolyte contains a first lithium salt, and the first lithium salt is selected from at least one of lithium bis(trifluoromethanesulfonyl)imide, lithium bis(fluorosulfonyl)imide, and lithium trifluoromethanesulfonate; and the electrolyte contains a second lithium salt, and the second lithium salt is selected from at least one of lithium tetrafluoroborate or lithium difluorophosphate; where based on mass of the electrolyte, a mass percentage of the first lithium salt is S₁% and a mass percentage of the second lithium salt is S₂%, where 0.2≤S₂/S₁≤2; preferably, 0.4≤S₂/S₁≤1.6. For example, the value of S₂/S₁ may be 0.2, 0.4, 0.5, 0.7, 0.9, 1.1, 1.4, 1.5, 1.7, 1.9, 2, or a value within a range defined by any two of these values. When the electrolyte contains the first lithium salt and second lithium salt, the compactness and stability of the SEI film can be improved and the ionic conductivity of the electrolyte can be increased. This can further improve the cycling performance and rate performance of the secondary battery when combined with the foregoing negative electrode system.

In some embodiments, 0.5≤S₁≤5. For example, the value of S₁ may be 0.5, 0.6, 1.1, 1.6, 2.2, 2.7, 3.1, 3.6, 4.0, 4.9, 5, or a value within a range defined by any two of these values. In some embodiments, 0.2≤S₂≤1.2. For example, the value of S₂ may be 0.2, 0.3, 0.4, 0.5, 0.6, 0.7, 0.8, 0.9, 1.0, 1.1, 1.2, or a value within a range defined by any two of these values. When the foregoing condition is satisfied, the cycling performance and rate performance of the secondary battery can be further improved.

According to some embodiments of this application, the lithium salt may include but is not limited to at least one of lithium hexafluorophosphate (LiPF₆), lithium tetrafluoroborate (LiBF₄), lithium difluorophosphate (LiPO₂F₂), lithium bis(oxalato)borate {LiB(C₂O₄)₂, LiBOB}, lithium difluoro(oxalato)borate {LiBF₂(C₂O₄), LiDFOB}, LiNO₃, LiClO₄, LiB(C₆H₅)₄, LiCH₃SO₃, LiCF₃SO₃, LiC(SO₂CF₃)₃, Li₂SiF₆, or lithium difluoroborate. This application does not limit the proportion of the lithium salt in the electrolyte as long as the objective of this application can be achieved.

This application does not particularly limit the non-aqueous solvent. For example, the non-aqueous solvent may include but is not limited to at least one of a carbonate compound, a carboxylate compound, an ether compound, or another organic solvent. The carbonate compound may include but is not limited to at least one of a chain carbonate compound, a cyclic carbonate compound, or a fluorinated carbonate compound. The chain carbonate compound may include but is not limited to at least one of dimethyl carbonate (DMC), diethyl carbonate (DEC), dipropyl carbonate, methyl propyl carbonate, ethyl propyl carbonate, or methyl ethyl carbonate (EMC). The cyclic carbonate may include but is not limited to at least one of propylene carbonate (PC), butylene carbonate, or vinylene carbonate. The fluorinated carbonate compound may include but is not limited to at least one of 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include but is not limited to at least one of methyl formate, methyl acetate, ethyl acetate, n-propyl acetate, tert-butyl acetate, methyl propionate, ethyl propionate, propyl propionate, 7-butyrolactone, decanolactone, valerolactone, or caprolactone. The ether compound may include but is not limited to at least one of 1,3-dioxolane (DOL), ethylene glycol dimethyl ether (1,2-dimethoxyethane, DME), dibutyl ether, tetraglyme, diglyme, 1,2-diethoxyethane, 1-ethoxy-1-methoxyethane, 2-methyltetrahydrofuran, or tetrahydrofuran.

### Electronic Apparatus

This application provides an electronic apparatus including the foregoing secondary battery. The electronic apparatus of this application is not particularly limited and may be any electronic apparatus known in the prior art. For example, the electronic apparatus may include but is not limited to a notebook computer, a pen-based computer, a mobile computer, an electronic book reader, a portable telephone, a portable facsimile machine, a portable copier, a portable printer, a stereo headset, a video recorder, a liquid crystal television, a handheld cleaner, a portable CD player, a mini disc, a transceiver, an electronic notebook, a calculator, a memory card, a portable recorder, a radio, a backup power supply, a motor, an automobile, a motorcycle, a motorized bicycle, a bicycle, a lighting appliance, a toy, a game console, a clock, an electric power tool, a flash lamp, a camera, a large household battery, or a lithium-ion capacitor.

### Measurement Methods

The physical properties mentioned in this application may be measured using the following methods, and the physical properties in the following examples and comparative examples are measured using the following methods.

Test of Charge-Discharge Cycle Curve and Differential Voltage-Capacity dQ/dV Curve

A porous carbon material (96 wt %), a conductive agent carbon black (1.5 wt %), a binder polymethyl acrylate (1.5 wt %), and a thickener sodium carboxymethyl cellulose (1 wt %) were mixed, water was added, and then the resulting mixture was stirred to uniformity to obtain a slurry. The slurry was applied on a copper foil to form a 50 μm-thick coating and dried to obtain an electrode plate. Metallic lithium was used as a counter electrode. The electrode plate (cut into a diameter of 18 mm), a separator (a 12 μm-thick polyethylene microporous membrane), and a lithium sheet with a diameter of 18 mm and a thickness of 0.6 mm were stacked in sequence, the electrolyte of Example 1-1 was added, and the assembly was encapsulated in a coin-shaped stainless steel shell to obtain a button cell.

The button cell was discharged to 0.005 V at a constant current of 0.1C, left standing for 5 minutes, and then discharged to 0.005 V at a constant current of 0.05C. After 5 minutes of standing, the button cell was discharged to 0.005 V at a constant current of 0.02C, left standing for 5 minutes, and then discharged to 0.005 V at a constant current of 0.01C. After 5 minutes of standing, the button cell was charged to 2 V at a constant current of 0.05C. The specific charge capacities of the porous carbon material were recorded at 0.15 V and 0.8 V during charging. The data obtained from these charge-discharge cycles were processed to obtain the differential voltage-capacity dQ/dV curve of the porous carbon material.

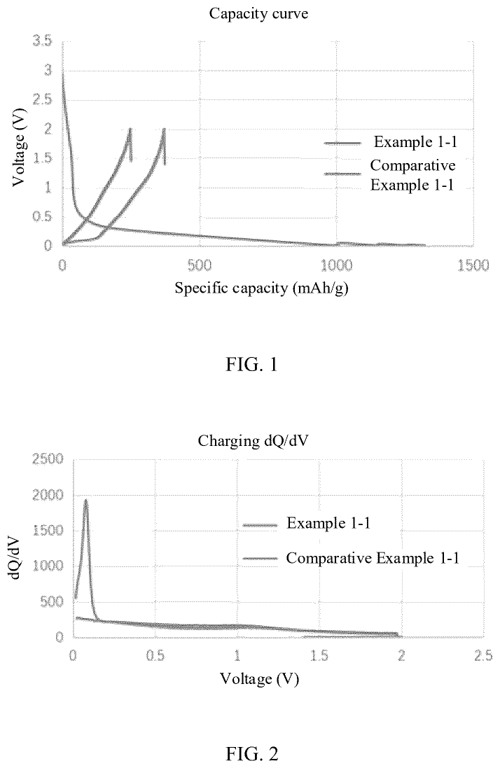

FIG. 1 is a diagram of charge-discharge cycling curves of porous carbon materials provided by Example 1-1 and Comparative Example 1-1 of this application. FIG. 2 is a diagram of differential voltage-capacity dQ/dV curves of porous carbon materials provided by Example 1-1 and Comparative Example 1-1 of this application.

The foregoing porous carbon material was replaced with a silicon-carbon material, the charging and discharging process was tested, and then the first-cycle Coulombic efficiency of the silicon-carbon material was calculated by dividing the specific charge capacity at 0.8 V by the total discharge capacity.

### True Density Test

An amount of porous carbon material was put into a true density meter, helium gas was introduced according to a procedure, the gas pressures in the swelling chamber and the sample chamber were measured, the true volume v of the sample was calculated according to the Boyle's law PV=nRT, and then the true density of the porous carbon material was calculated according to ρ=m/v.

### Test of Specific Surface Area, Pore Volume, and Pore Size Distribution

A physisorption analyzer (model: iPore 620) was used to test the porous carbon material according to the following procedure: putting 0.15 g of the porous carbon material sample into a sample tube, degassing at 200° C. for 6 hours, and then testing the amount of argon gas absorbed by the sample under different pressures. An isothermal adsorption curve of the sample was drawn. The specific surface area of the sample was calculated by BET fitting. The pore volume and pore size distribution of the sample were calculated by non-local density functional theory (NLDFT) fitting to obtain the pore volume percentages of first pores and second pores based on the pore volume.

### Performance Test

### Rate Performance Test of Full Lithium-Ion Battery

A to-be-tested full lithium-ion battery according to an example or comparative example was left standing for 5 minutes at a test temperature of 25° C., charged to 4.45 V at a constant current of 0.7C, and then charged to 0.05C at a constant voltage of 4.45 V. After 5 minutes of standing, the full battery was discharged to 3.0 V at a constant current of 0.2C, and the discharge capacity at 0.2C was recorded. After 5 minutes of standing, the foregoing charging process was repeated, the full battery was then discharged at a constant current of 2C, and the discharge capacity at 2C was recorded. Rate capacity retention rate=discharge capacity at 2C/discharge capacity at 0.2C×100%.

### Cycling Performance Test of Full Lithium-Ion Battery

At a test temperature of 25° C., a full lithium-ion battery to be tested was left standing for 5 minutes, and the initial thickness MMC0 of the full lithium-ion battery was recorded. The full lithium-ion battery was charged to 4.25 V at a constant current of 3.4C, charged to 4.4 V at 2C, charged to 4.50 V at 1C, and then charged to 0.05C at a constant voltage of 4.50 V. After 5 minutes of standing, the full battery was discharged to 3.0 V at a constant current of 0.5C. After 5 minutes of standing, the discharge capacity C1 of the full lithium-ion battery was recorded. After 400 charge-discharge cycles involving 3.4C charging and 0.5C discharging were performed, the thickness MMC1 and discharge capacity C2 of the full lithium-ion battery were recorded.

$$Cycling capacity retention rate ( \% ) = C 2 / C 1 \times 100 \% .$$

$$Cycling thickness swelling rate ( \% ) = ( MMC 1 - MMC 0 ) / MMC 0 \times 100 \% .$$

The technical solution of this application will be described by taking lithium-ion batteries as an example and with reference to the following specific examples. Unless otherwise specified, the raw materials used in the following examples are all commercially available, and the apparatuses or devices used are all purchased from conventional market sales channels.

### Example 1-1

### Preparation of Porous Carbon Material and Silicon-Carbon Material

Step S1. Elemental nickel was dispersed in water, and phenol, sodium hydroxide, and formaldehyde were added in sequence for a polymerization reaction to obtain a phenolic resin material as a porous carbon material precursor. The molar ratio of phenol, formaldehyde, and sodium hydroxide was 1:2.1:0.1. The phenolic resin material contained catalytic elemental nickel, and based on the mass of the phenolic resin material, the mass percentage of elemental nickel was 0.2%.
Step S2. The phenolic resin material containing 0.2 wt % of elemental nickel was carbonized at 900° C. in a nitrogen atmosphere for 4 hours to obtain a carbonized material.
Step S3. The carbonized material was mixed with an activator potassium hydroxide (KOH) to uniformity at a mass ratio of 1:2.5, and the mixture was activated at 950° C. in a nitrogen atmosphere for 2 hours to obtain an activated material.
Step S4. The activated material was washed with deionized water, hydrochloric acid was added to neutralize excess alkali, impurities were washed away with deionized water, and then moisture was removed by drying at 150° C. The dried activated material was roasted at 900° C. in a mixed gas atmosphere of methane and nitrogen for 4 hours to obtain a porous carbon material. The volume ratio of methane to nitrogen was 1:10.
Step S5. The porous carbon material was placed in a reactor, silane gas was introduced at 440° C. for reaction for 6 hours, the temperature was raised to 500° C., and then acetylene gas was introduced for 2 hours of reaction to obtain a silicon-carbon material.

### Preparation of Full Lithium-Ion Battery

### Preparation of Negative Electrode

The silicon-carbon material and artificial graphite were mixed at a mass ratio of 1:5 to obtain a negative electrode material. The negative electrode material (96 wt %), a conductive agent carbon black (1.5 wt %), a binder polymethyl acrylate (1.5 wt %), and a thickener sodium carboxymethyl cellulose (1 wt %) were mixed, deionized water is added, and the resulting mixture was stirred to uniformity to prepare a negative electrode slurry. The negative electrode slurry was uniformly applied on one surface of a copper foil and dried. The foregoing steps were repeated on another surface of the copper foil to obtain a negative electrode plate with the negative electrode material layer coated on both sides. The coated copper foil was dried, pressed, and cut into a specified size, followed by tab welding, to obtain a negative electrode.

### Preparation of Positive Electrode

Lithium cobalt oxide (97 wt %), a conductive agent carbon black (1.5 wt %), and a binder polyvinylidene fluoride (1.5 wt %) were mixed in N-methylpyrrolidone to prepare a positive electrode slurry. The positive electrode slurry was uniformly applied on one surface of an aluminum foil and dried. The coating step was repeated on another surface of the aluminum foil to obtain a positive electrode plate with a positive electrode material layer coated on both sides. The coated aluminum foil was dried, pressed, and cut into a specified size, followed by tab welding, to obtain a positive electrode.

Preparation of separator: A 12 μm-thick polyethylene microporous membrane was used as the separator.

### Preparation of Electrolyte

In an argon atmosphere glove box with a water content of less than 10 ppm, dimethyl carbonate and diethyl carbonate were mixed at a mass ratio of 1:1 to obtain a base solvent. Ethylene carbonate, fluoroethylene carbonate, and lithium hexafluorophosphate were added to the base solvent and mixed to uniformity to obtain an electrolyte. Based on the mass of the electrolyte, a mass percentage of lithium hexafluorophosphate was 12.5%, a mass percentage of ethylene carbonate was 10%, a mass percentage of fluoroethylene carbonate was 10%, and the remainder was dimethyl carbonate and diethyl carbonate (at a mass ratio of 1:1).

### Battery Assembly

The positive electrode, the separator, and the negative electrode were stacked in sequence, with the separator located between the positive electrode and the negative electrode for isolation, and wound to obtain an electrode assembly. The electrode assembly was placed in an outer packaging aluminum-plastic film, baked, injected with the foregoing electrolyte, and then subjected to processes including vacuum packaging, standing, formation, shaping, and capacity testing to obtain a full lithium-ion battery.

As shown in Table 1, Examples 1-2 to 1-6 and Examples 2-1 to 2-4 are the same as Example 1-1 except the type or proportion of the catalytic metal.

TABLE 1

| | Carbon precursor | Catalytic | Mass percentage of |
|---|---|---|---|
| Example | type | metal | catalytic metal (%) |
| Example 1-1 | Phenolic resin | Ni | 0.2 |
| Example 1-2 | Phenolic resin | Ni | 0.15 |
| Example 1-3 | Phenolic resin | Ni | 0.1 |
| Example 1-4 | Phenolic resin | Ni | 0.05 |
| Example 1-5 | Phenolic resin | Ni | 0.004 |
| Example 1-6 | Phenolic resin | Ni | 0.5 |
| Example 2-1 | Phenolic resin | Fe | 0.2 |
| Example 2-2 | Phenolic resin | V | 0.2 |
| Example 2-3 | Phenolic resin | Ca | 0.2 |
| Example 2-4 | Phenolic resin | Co | 0.2 |

As shown in Table 2, Comparative Example 1-1 is the same as Example 1-1 except that no catalytic metal is added. Comparative Example 1-2 is the same as Comparative Example 1-1 except the carbonization temperature T₁. Examples 3-1 to 3-4 are the same as Example 1-1 except the carbonization temperature T₁. Examples 3-5 and 3-6 are the same as Example 1-1 except the duration of the carbonization treatment.

TABLE 2

| | Temperature | Duration | Activator | Temperature | Duration |
|---|---|---|---|---|---|
| Example | T₁ (° C.) | t₁ (h) | atmosphere | T₂ (° C.) | t₂ (h) |
| Comparative | 900 | 4 | KOH | 950 | 2 |
| Example 1-1 | | | | | |
| Comparative | 700 | 4 | KOH | 950 | 2 |
| Example 1-2 | | | | | |
| Example 3-1 | 750 | 4 | KOH | 950 | 2 |
| Example 3-2 | 900 | 4 | KOH | 950 | 2 |
| Example 3-3 | 1100 | 4 | KOH | 950 | 2 |
| Example 3-4 | 1200 | 4 | KOH | 950 | 2 |
| Example 3-5 | 900 | 1 | KOH | 950 | 2 |
| Example 3-6 | 900 | 10 | KOH | 950 | 2 |

As shown in Table 3, Examples 4-1 to 4-5 are the same as Example 1-1 except the temperature T₃ and duration t₃ of roasting treatment.

TABLE 3

| Example | Temperature T₃ (° C.) | Duration t₃ (h) |
|---|---|---|
| Example 4-1 | 800 | 4 |
| Example 4-2 | 1000 | 4 |
| Example 4-3 | 800 | 2 |
| Example 4-4 | 900 | 2 |
| Example 4-5 | 900 | 6 |

Table 4 shows the test results of the foregoing examples and comparative examples.

TABLE 4

| | | | | | | | | First-cycle | | | |
|---|---|---|---|---|---|---|---|---|---|---|---|
| | | | | | | | | Coulombic | | | |
| | | | | | | Volume | | efficiency | | | |
| | Capacity | Capacity | First | Specific | | percentage | | of silicon- | Rate | Cycling | Cycling |
| | at 0.005- | at 0.005- | characteristic | surface | Pore | of first | True | carbon | capacity | capacity | thickness |
| | 0.8 V | 0.15 V | peak height | area | volume | pores P₁ | density | material | retention | retention | swelling |
| Example | (mAh/g) | (mAh/g) | (mAh/g/V) | SA | Pv | (%) | (cm³/g) | (%) | rate (%) | rate (%) | rate (%) |
| Example 1-1 | 253.4 | 132 | 1927 | 1830 | 0.82 | 95.2 | 2.003 | 87.0 | 92.4 | 88.3 | 10.1 |
| Example 1-2 | 196 | 89 | 1158 | 1885 | 0.85 | 96.5 | 2.010 | 85.9 | 91.8 | 87.5 | 11.2 |
| Example 1-3 | 174 | 75 | 760 | 1950 | 0.88 | 97.0 | 2.120 | 84.2 | 90.9 | 86.6 | 11.8 |
| Example 1-4 | 165 | 58 | 362 | 2004 | 0.89 | 97.2 | 2.160 | 81.5 | 89.3 | 85.9 | 11.9 |
| Example 1-5 | 152 | 43 | 260 | 2035 | 0.91 | 97.5 | 2.230 | 80.2 | 88.6 | 85.7 | 12.3 |
| Example 1-6 | 182 | 81 | 1100 | 1680 | 0.68 | 96.0 | 2.050 | 85.1 | 91.2 | 86.9 | 11.4 |
| Example 2-1 | 178 | 78 | 782 | 1920 | 0.86 | 97.5 | 2.140 | 84.8 | 91.2 | 86.9 | 11.6 |
| Example 2-2 | 165 | 48 | 392 | 1890 | 0.88 | 97.2 | 2.172 | 81.6 | 90.2 | 86.1 | 11.8 |
| Example 2-3 | 158 | 45 | 330 | 1933 | 0.91 | 96.4 | 2.180 | 80.7 | 88.7 | 85.8 | 11.9 |
| Example 2-4 | 162 | 47 | 361 | 1894 | 0.87 | 96.8 | 2.168 | 81.6 | 89.1 | 85.4 | 12.1 |
| Comparative | 136 | 31 | 125 | 2004 | 0.91 | 99.2 | 2.160 | 77.8 | 88.3 | 85.1 | 12.9 |
| Example 1-1 | | | | | | | | | | | |
| Comparative | 144 | 35 | 130 | 1830 | 0.82 | 95.4 | 2.003 | 78.9 | 89.2 | 85.3 | 12.1 |
| Example 1-2 | | | | | | | | | | | |
| Example 3-1 | 166 | 62 | 382 | 1830 | 0.82 | 95.2 | 2.003 | 82.1 | 89.8 | 85.8 | 11.9 |
| Example 3-2 | 212 | 96 | 1260 | 1850 | 0.86 | 95.8 | 2.006 | 86.5 | 91.8 | 87.7 | 11.0 |
| Example 3-3 | 194 | 88 | 1180 | 1869 | 0.80 | 93.8 | 2.012 | 86.2 | 91.6 | 87.5 | 11.0 |
| Example 3-4 | 190 | 86 | 1156 | 1902 | 0.76 | 92.8 | 2.100 | 85.8 | 91.3 | 86.9 | 11.2 |
| Example 3-5 | 198 | 91 | 1192 | 1878 | 0.87 | 95.4 | 2.009 | 86.0 | 91.9 | 87.7 | 10.9 |
| Example 3-6 | 186 | 84 | 1142 | 1752 | 0.80 | 92.4 | 2.042 | 85.4 | 91.3 | 86.6 | 11.4 |
| Example 4-1 | 180 | 80 | 1120 | 1890 | 0.88 | 98.1 | 2.048 | 85.0 | 91.3 | 87.0 | 11.6 |
| Example 4-2 | 216 | 96 | 1302 | 1842 | 0.78 | 93.2 | 2.006 | 86.8 | 92.0 | 88.0 | 10.4 |
| Example 4-3 | 176 | 75 | 788 | 1890 | 0.86 | 98.2 | 2.100 | 84.4 | 90.6 | 86.7 | 11.6 |
| Example 4-4 | 197 | 91 | 1168 | 1890 | 0.84 | 96.3 | 2.110 | 86.0 | 91.8 | 87.6 | 11.1 |
| Example 4-5 | 213 | 94 | 1289 | 1890 | 0.80 | 94.8 | 2.007 | 86.6 | 92.0 | 88.1 | 10.5 |

From the performance test results of Examples 1-1 to 1-6, it can be learned that as the mass percentage of the catalytic metal increases, the specific charge capacity (hereinafter referred to as “0.15 V and 0.8 V capacities of the porous carbon material”) of the button cell assembled from the porous carbon material increases both in the 5 voltage ranges of 0.005 V to 0.15 V and 0.005 V to 0.8 V. Apparently, adding a catalytic metal to the porous carbon material precursor in this application can promote carbon rearrangement, enabling carbon to generate ordered local graphite microcrystals and thereby increasing the capacity of the porous carbon material. The degree of order of the porous carbon material and the pore-forming effect in the subsequent activation process can be balanced by controlling the mass percentage of the catalytic metal. This can further increase the capacity when combined with the closed-pore structure formed by disordered carbon stacking during roasting treatment.

From Examples 2-1 to 2-4 and Comparative Example 1-1, it can be learned that in this application, using a transition metal such as Fe, Co, and V as the catalytic metal can increase the 0.15 V and 0.8 V capacities of the porous carbon material.

From the test results of Examples 3-1 to 3-4, it can be learned that when the temperature of the carbonization treatment rises, the 0.15 V and 0.8 V capacities of the porous carbon material first increase and then decrease. This is mainly because that a higher temperature helps increase the degree of order of carbon microcrystals, but an excessively high temperature instead reduces closed pores and therefore reduces the 0.15 V and 0.8 V capacities of the porous carbon material. From the comparison between Examples 3-5 to 3-6 and Example 1-1, it can be learned that adjusting the duration of the carbonization treatment can affect the 0.15 V and 0.8 V capacities of the porous carbon material.

From the results of Examples 4-1 to 4-5 and Example 1-1, it can be learned that a higher roasting treatment temperature can increase closed pores to some extent and therefore increase the 0.15 V and 0.8 V capacities of the porous carbon material; however, if the carbon temperature is excessively high or the reaction duration is excessively long, pore melting occurs in the porous carbon material, which reduces the amount of closed pores and therefore reduces the 0.15 V and 0.8 V capacities of the porous carbon material.

According to the results in Table 1, it can be learned that in this application, when the porous carbon material is controlled to provide specific charge capacity in the voltage ranges of 0.005 V to 0.15 V and 0.005 V to 0.8 V and the height of the first characteristic peak located at 0.005-0.15 V in the differential voltage-capacity dQ/dV curve is controlled within the foregoing range, the lithium ion transport capability of the porous carbon material can be enhanced in the foregoing voltage ranges, which can increase the first-cycle Coulombic efficiency of the silicon-carbon material and improve the cycling performance and rate performance of the secondary battery. In particular, when the true density of the porous carbon material is controlled within the range of 2.003 g/cm³ to 2.230 g/cm³ and at least a portion of the porous carbon material has a lattice structure, the rate performance and cycling performance of the secondary battery can be improved, and the first-cycle Coulombic efficiency of the silicon-carbon material can be improved.

In particular, when the specific surface area, pore volume, and pore volume percentage of first pores of the porous carbon material are controlled within the foregoing ranges, the rate performance and cycling performance of the secondary battery can be further improved, and the first-cycle Coulombic efficiency of the silicon-carbon material can be improved.

As shown in Table 5, the difference between Examples 5-1 to 5-3 and Example 1-1 lies in that: the mass percentages of ethylene carbonate and fluoroethylene carbonate in the electrolyte are adjusted. Table 5 shows the specific adjustments to parameters and performance test results. In addition, the proportion of the base solvent is adjusted accordingly, where the mass ratio of dimethyl carbonate to diethyl carbonate remains unchanged.

TABLE 5

| | Mass | Mass | | | | |
|---|---|---|---|---|---|---|
| | percentage of | percentage of | | Rate | Cycling | Cycling |
| | ethylene | fluoroethylene | | capacity | capacity | thickness |
| | carbonate C1 | carbonate C2 | C2/ | retention | retention | swelling |
| No. | (%) | (%) | C1 | rate (%) | rate (%) | rate (%) |
| Example 1-1 | 10 | 10 | 1 | 92.4 | 88.3 | 10.1 |
| Example 5-1 | 12 | 6 | 0.5 | 88.7 | 86.2 | 10.8 |
| Example 5-2 | 6 | 9 | 1.5 | 91.6 | 89.3 | 9.7 |
| Example 5-3 | 5 | 10 | 2 | 89.2 | 86.9 | 10.9 |

It can be learned from Table 5 that in this application, when the mass percentage C₁% of ethylene carbonate and the mass percentage C₂% of fluoroethylene carbonate in the electrolyte are controlled as 0.5≤C₂/C₁≤2, the cycling performance and rate performance of the secondary battery can be further improved. In particular, when 1≤C₂/C₁≤1.5 holds, the cycling performance and rate performance of the secondary battery can be further improved.

As shown in Table 6, the difference between Examples 6-1 to 6-4 and Example 5-2 lies in that: the mass percentages of the first lithium salt and the second lithium salt in the electrolyte are adjusted. Table 6 shows the specific adjustments to parameters and performance test results. In addition, the proportion of the base solvent is adjusted accordingly, where the mass ratio of dimethyl carbonate to diethyl carbonate remains unchanged.

TABLE 6

| | | Proportion | | Proportion | | | | |
|---|---|---|---|---|---|---|---|---|
| | | of first | | of second | | Rate | Cycling | Cycling |
| | | lithium | | lithium | | capacity | capacity | thickness |
| | | salt S1 | Type of second | salt S2 | S2/ | retention | retention | swelling |
| No. | Type of first lithium salt | (%) | lithium salt | (%) | S1 | rate (%) | rate (%) | rate (%) |
| Example | Lithium | 1 | Lithium | 0.4 | 0.4 | 91.6 | 89.3 | 9.7 |
| 5-2 | bis(trifluoromethanesulfonyl) | | tetrafluoroborate | | | | | |
| | imide | | | | | | | |
| Example | Lithium | 1 | Lithium | 0.2 | 0.2 | 88.9 | 87.3 | 9. |
| 6-1 | bis(trifluoromethanesulfonyl) | | tetrafluoroborate | | | | | |
| | imide | | | | | | | |
| Example | Lithium | 0.5 | Lithium | 0.4 + 0.4 | 1.6 | 90.3 | 90.5 | 8.3 |
| 6-2 | bis(trifluoromethanesulfonyl) | | tetrafluoroborate + | | | | | |
| | imide | | lithium | | | | | |
| | | | difluorophosphate | | | | | |
| Example | Lithium | 0.5 | Lithium | 0.6 + 0.6 | 2 | 90.2 | 88.5 | 9.9 |
| 6-3 | bis(trifluoromethanesulfonyl) | | tetrafluoroborate + | | | | | |
| | imide | | lithium | | | | | |
| | | | difluorophosphate | | | | | |

It can be seen from Table 6 that when the mass percentage S₁% of the first lithium salt and the mass percentage S₂% of the second lithium salt in the electrolyte are controlled as 0.2≤S₂/S₁≤2, the cycling performance and rate performance of the secondary battery can be further improved. In particular, when 0.4≤S₂/S₁≤1.6 holds, the cycling performance and rate performance of the secondary battery can be further improved.

The foregoing descriptions are merely preferred embodiments of this application, but are not intended to limit this application. Any modification, equivalent replacement, or improvement made without departing from the principle of this application shall fall within the protection scope of this application.

What is claimed is:

1. A porous carbon material, wherein a specific charge capacity within a voltage range of 0.005 V to 0.15 V of the porous carbon material is Q1, Q1 is in the range of 43 mAh/g to 132 mAh/g, and a specific charge capacity within a voltage range of 0.005 V to 0.8 V of the porous carbon material is Q2, Q2 is in the range of 152 mAh/g to 253.4 mAh/g;
a differential voltage-capacity dQ/dV curve of the porous carbon material has a first characteristic peak located in the range of 0.005 to 0.15 V, and a peak height of the first characteristic peak is not less than 260 mAh/g/V,
wherein a test method of Q1, Q2 and the differential voltage-capacity dQ/dV curve of the porous carbon material includes: assembling the porous carbon material and lithium metal into a button cell, and then charging the button cell at a current of 0.05C within a voltage range of 0.005 V to 2 V.

2. The porous carbon material according to claim 1, wherein the porous carbon material satisfies at least one of the following conditions:
(1) a true density of the porous carbon material is in the range of 2.003 g/cm³ to 2.230 g/cm³; and at least a portion of the porous carbon material has a lattice structure; or
(2) the peak height of the first characteristic peak is in the range of 260 mAh/g/V to 1927 mAh/g/V.

3. The porous carbon material according to claim 1, wherein the porous carbon material satisfies at least one of the following conditions:
(1) Q1 is in the range of 75 mAh/g to 132 mAh/g, and Q2 is in the range of 174 mAh/g to 253.4 mAh/g; or
(2) the peak height of the first characteristic peak is in the range of 760 mAh/g/V 30 to 1927 mAh/g/V.

4. The porous carbon material according to claim 1, wherein the porous carbon material satisfies at least one of the following conditions:
(1) wherein a specific surface area of the porous carbon material is in the range of 1752 m²/g to 2035 m²/g; or
(2) a pore volume of the porous carbon material is in the range of 0.68 cm³/g to 0.91 cm³/g.

5. The porous carbon material according to claim 4, wherein the porous carbon material has first pores and second pores, the first pores have a pore size of less than 2 nm, and the second pores have a pore size of greater than 2 nm and less than or equal to 10 nm; wherein
based on a sum of a pore volume of the first pores and a pore volume of the second pores, a pore volume percentage of the first pores is in the range of 92.4% to 98.2%.

6. A method for preparing the porous carbon material according to claim 1, the method comprising following steps:
step S1: dispersing a catalytic elemental metal to obtain a dispersion system; and polymerizing a monomer in the dispersion system to obtain a porous carbon material precursor, wherein the catalytic elemental metal comprises at least one selected from the group consisting of iron, cobalt, nickel, vanadium, chromium, manganese, zinc, tin, calcium, magnesium, and aluminum; a mass percentage of the catalytic elemental metal in the porous carbon material precursor is 0.004% to 0.500%; and the monomer comprises a phenolic compound and an aldehydic compound;
step S2: carbonizing the porous carbon material precursor at a temperature of T₁° C. for a duration time of t₁ hours to obtain a carbonized material, wherein 750° C.≤T₁≤1200° C. and 1≤t₁≤10;
step S3: mixing the carbonized material with an activator and then activating the mixture at a temperature of T₂° C. for a duration time of t₂ hours to obtain an activated material, wherein 700° C.≤T₂≤1100° C. and 1≤t₂≤6; and
step S4: washing and then drying the activated material; and roasting the dried activated material at a temperature of T₃° C. for a duration time of t₃ hours in a mixed gas atmosphere of an alkane and an inert gas to obtain the porous carbon material, wherein 600° C.≤T₃≤1400° C., 2≤t₃≤8, and a volume ratio of the alkane to the inert gas is 1:(5-10).

7. A silicon-carbon material, wherein the silicon-carbon material comprises a porous carbon material, nano-silicon located inside the porous carbon material, and a carbon layer located on a surface of the porous carbon material; wherein
wherein a specific charge capacity within a voltage range of 0.005 V to 0.15 V of the porous carbon material is Q1, Q1 is in the range of 43 mAh/g to 132 mAh/g, and a specific charge capacity within a voltage range of 0.005 V to 0.8 V of the porous carbon material is Q2, Q2 is in the range of 152 mAh/g to 253.4 mAh/g;
a differential voltage-capacity dQ/dV curve of the porous carbon material has a first characteristic peak located in the range of 0.005 to 0.15 V, and a peak height of the first characteristic peak is not less than 260 mAh/g/V,
wherein a test method of Q1, Q2 and the differential voltage-capacity dQ/dV curve of the porous carbon material includes: assembling the porous carbon material and lithium metal into a button cell, and then charging the button cell at a current of 0.05C within a voltage range of 0.005 V to 2 V.

8. The silicon-carbon material according to claim 7, wherein the porous carbon material satisfies at least one of the following conditions:
(1) a true density of the porous carbon material is in the range of 2.003 g/cm³ to 2.230 g/cm³; and at least a portion of the porous carbon material has a lattice structure; or
(2) the peak height of the first characteristic peak is in the range of 260 mAh/g/V to 1927 mAh/g/V.

9. The silicon-carbon material according to claim 7, wherein the porous carbon material satisfies at least one of the following conditions:
(1) Q1 is in the range of 75 mAh/g to 132 mAh/g, and Q2 is in the range of 174 mAh/g to 253.4 mAh/g; or
(2) the peak height of the first characteristic peak is in the range of 760 mAh/g/V to 1927 mAh/g/V.

10. The silicon-carbon material according to claim 7, wherein the porous carbon material satisfies at least one of the following conditions:
(1) wherein a specific surface area of the porous carbon material is in the range of 1752 m²/g to 2035 m²/g; or
(2) a pore volume of the porous carbon material is in the range of 0.68 cm³/g to 0.91 cm³/g.

11. The silicon-carbon material according to claim 10, wherein the porous carbon material has first pores and second pores, the first pores have a pore size of less than 2 nm, and the second pores have a pore size of greater than 2 nm and less than or equal to 10 nm; wherein
based on a sum of a pore volume of the first pores and a pore volume of the second pores, a pore volume percentage of the first pores is in the range of 92.4% to 98.2%.

12. A secondary battery, comprising a positive electrode, a negative electrode, and an electrolyte; wherein the negative electrode comprises a negative electrode current collector and a negative electrode material layer located on at least a part of a surface of the negative electrode current collector, and the negative electrode material layer comprises the silicon-carbon material according to claim 7.

13. The secondary battery according to claim 12, wherein a true density of the porous carbon material is in the range of 2.003 g/cm³ to 2.230 g/cm³; and at least a portion of the porous carbon material has a lattice structure.

14. The secondary battery material according to claim 12, wherein the peak height of the first characteristic peak is in the range of 260 mAh/g/V to 1927 mAh/g/V.

15. The secondary battery material according to claim 12, wherein the porous carbon material satisfies at least one of the following conditions:
(1) Q1 is in the range of 75 mAh/g to 132 mAh/g, and Q2 is in the range of 174 mAh/g to 253.4 mAh/g; or
(2) the peak height of the first characteristic peak is in the range of 760 mAh/g/V 10 to 1927 mAh/g/V.

16. The secondary battery material according to claim 12, wherein the porous carbon material satisfies at least one of the following conditions:
(1) wherein a specific surface area of the porous carbon material is in the range of 1752 m²/g to 2035 m²/g; or
(2) a pore volume of the porous carbon material is in the range of 0.68 cm³/g to 0.91 cm³/g.

17. The secondary battery material according to claim 16, wherein the porous carbon material has first pores and second pores, the first pores have a pore size of less than 2 nm, and the second pores have a pore size of greater than 2 nm and less than or equal to 10 nm; wherein
based on a sum of a pore volume of the first pores and a pore volume of the second pores, a pore volume percentage of the first pores is in the range of 92.4% to 98.2%.

18. The secondary battery according to claim 12, wherein the electrolyte contains ethylene carbonate and fluoroethylene carbonate; wherein
based on mass of the electrolyte, a mass percentage of ethylene carbonate is C₁%, a mass percentage of fluoroethylene carbonate is C₂%, and 0.5≤C₂/C₁≤2.

19. The secondary battery according to claim 12, wherein the electrolyte contains a first lithium salt; and the first lithium salt is at least one selected from the group consisting of lithium bis(trifluoromethanesulfonyl)imide, lithium bis(fluorosulfonyl)imide, and lithium trifluoromethanesulfonate; and
the electrolyte contains a second lithium salt, and the second lithium salt is at least one selected from the group consisting of lithium tetrafluoroborate and lithium difluorophosphate; wherein
based on a mass of the electrolyte, a mass percentage of the first lithium salt is S₁% and a mass percentage of the second lithium salt is S₂%, wherein 0.2≤S₂/S₁≤2.

20. An electronic apparatus, comprising a secondary battery; wherein the secondary battery comprises a positive electrode, a negative electrode, and an electrolyte, wherein the negative electrode comprises a negative electrode current collector and a negative electrode material layer located on at least a part of a surface of the negative electrode current collector, and the negative electrode material layer comprises a silicon-carbon material; wherein the silicon-carbon material comprises a porous carbon material, nano-silicon located inside the porous carbon material, and a carbon layer located on a surface of the porous carbon material; wherein
wherein a specific charge capacity within a voltage range of 0.005 V to 0.15 V of the porous carbon material is Q1, Q1 is in the range of 43 mAh/g to 132 mAh/g, and a specific charge capacity within a voltage range of 0.005 V to 0.8 V of the porous carbon material is Q2, Q2 is in the range of 152 mAh/g to 253.4 mAh/g;
a differential voltage-capacity dQ/dV curve of the porous carbon material has a first characteristic peak located in the range of 0.005 to 0.15 V, and a peak height of the first characteristic peak is not less than 260 mAh/g/V,
wherein a test method of Q1, Q2 and the differential voltage-capacity dQ/dV curve of the porous carbon material includes: assembling the porous carbon material and lithium metal into a button cell, and then charging the button cell at a current of 0.05C within a voltage range of 0.005 V to 2 V.
